(19) United States
(12) Patent Application Publication
(10) Pub. No.: US 2014/0121000 A1
(43) Pub. Date: May 1, 2014

(54) COMPUTERIZED REEL-BASED GAME SYSTEM AND METHODS FOR OPERATION USEFUL IN CONJUNCTION THEREWITH

(71) Applicant: Playtech Services (Cyprus) Limited, Nicosia (CY)

(72) Inventor: Andrew PORTER, London (GB)

(21) Appl. No.: 14/146,348

(22) Filed: Jan. 2, 2014

Related U.S. Application Data
(63) Continuation of application No. PCT/IB2012/053359, filed on Jul. 2, 2012.

(30) Foreign Application Priority Data
Jul. 1, 2011 (GB) 1111217.4
Nov. 28, 2011 (GB) 1120488.0

(51) Int. Cl. G07F 17/34

(52) U.S. Cl. CPC G07F 17/34
USPC 463/20

(57) ABSTRACT

A computerized reel-based game system including an array of indicators ordered by random or pseudorandom spin of reels; a processor applying rules to the location of the indicators to determine an outcome category corresponding to the particular array; a user interface enabling user-initiated positioning of overlay indicator/s at a selectable position in the array; a lock unit for, responsive to an actuation command, replacing an indicator to be positioned in the selected position resulting from a next spin by said overlay indicator/s, the processor applying the rules to the resultant array with said overlay indicator in the selected position; an actuation module computing, responsive to said user-initiated positioning of the overlay indicator, a stake paid according to the selected position and a cost associated therewith, to enable presenting the associated cost and, responsive to user's approval of the stake, generating said actuation command and sending it to the lock unit.

### REFERENCE TO CO-PENDING APPLICATIONS

Priority is claimed from both of:

GB Patent Application No. 1111217.4, filed by Ash Gaming Limited on 1 Jul. 2011.

GB Patent Application No. 1120488.0, filed by Ash Gaming Limited on 28 Nov. 2011 and entitled “A system and method”.

### FIELD OF THIS DISCLOSURE

The present invention relates generally to computerized games and more particularly to methods for controlling computerized games and servers for such.

### BACKGROUND FOR THIS DISCLOSURE

Conventional slot machines comprise multiple reels, each reel consisting of a set number of symbols denoted on each reel. The reels may be all (or selected ones may he) spun and then come to a stop in a framed window showing the symbols in the adjacent reels as an array of symbols or a set of “lines” of symbols. The stopping point and “spin” of the reels may be a random or pseudorandom process resulting in a particular configuration of the array or “lines” of symbols being visible through the window when the reels stop. The device typically has a processor typically configured as a computer processor. The processor has a set of rules which determine if a particular array of symbols represents a “win” outcome and any stake wagered by a user may be paid out in accordance with the category of winning outcome. Other lines of symbols do not represent a winning outcome and any stake wagered is lost. Slot games can be played for cash, credit, tokens or in a demonstration-only mode which are all entertaining. Slot machines are configured as mechanical devices, electro-mechanical devices or combinations thereof. FIG. 1 is a schematic representation of a conventional machine 100.

Some slot machines feature the use of “wilds”. A “wild” is a symbol on the reel which can be any one of the other symbols on the reel when the slot machine system is calculating whether there has been a winning outcome or not. Only selected reels may spin or all reels may spin. A user can press a “hold” button pre-spin to prevent rotation of a particular reel.

Published United States Patent Application No, 2007/0010316 to Baerlocher et al describes a gaming device wherein a reel or reel displaying a locking symbol may be fixed. The reels other than the reel displaying the locking symbol are then re-activated for free spins.

Published United States Patent Application No. 2007/0254735 to Marks et al describes a slot machine which re-spins unlocked symbol positions until all symbol positions are locked.

Published United States Patent Application No, 2006/0264254 to Aoki describes a gaming machine with rotatable reels having various wild features e.g. duplication of a wild into a combination of symbols to increase the probability to win.

The disclosures of all publications and patent documents mentioned in the specification, and of the publications and patent documents cited therein directly or indirectly, are hereby incorporated by reference. Materiality of such publications and patent documents to patentability is not conceded.

The disclosures of all publications and patent documents mentioned in the specification, and of the publications and patent documents cited therein directly or indirectly, are hereby incorporated by reference. Materiality of such publications and patent documents to patentability is not conceded.

### SUMMARY OF CERTAIN EMBODIMENTS

Certain embodiments of the present invention seek to provide slot machines and methods of operating slot machines. It is appreciated that in all embodiments shown and described herein, any suitable set of rules may be employed, not being limited to any particular rule described or implied herein. Whereas conventional machines offer only conventional levels of user interaction, certain embodiments of the present invention seeks to provide a machine which offers greater flexibility by allowing a user to determine, on-line, the location in the array of where wilds may be available for a subsequent spin. Such user choices, however, dynamically influence the stakes made and winnings payable if feasibility of the system is to be maintained. This additional layer of user involvement captures and maintains user interest in the machine for longer time periods than for conventional machines.

Certain embodiments of the present invention seek to provide a lock & spin feature including enabling a user's selection of desired symbols and a conditioned activation of lock and spin contingent on user's approval of a dynamic computation of extra price to be paid in response to his symbol selection, thereby to provide an engaging feature while dynamically maintaining economic feasibility of the system for operator. The “Lock and Spin” feature typically includes locking wilds in view from a prior spin and/or a specific user implemented configuration so as to retain them for pre-set inclusion in the result of the next spin.

The user may configure any one of the combinations of locked and unlocked wilds in a slot layout of symbols in view (for example, in the illustrated example embodiment, 3×5 reels yield 32,768 such combinations) by manually selecting wilds, or by selecting a stake and being given suitable configurations of wilds to match that stake, or, the gameplay may reach a configuration of wilds in view through normal slot machine play. Typically, the user is presented with a set price to “Lock and Spin” the wilds in view for the given configuration, the price being selected to yield a predicted long term payout outcome for all possible wilds in view combinations. Typically, all possible cost to play and payout return are computed for every possible wild in view combination, either dynamically per user input or in a set-up stage, in which case the resulting computations are predefined and stored as a lookup dataset which is matched on-line against user input.

Certain embodiments of the present invention seek to provide a first method for dynamic calculation of extra price to be paid in response to selection of certain options as per user's selection of symbols, by computing all possible combinations for wilds in view on 1 line of symbols (e.g. 5 symbols given a 3×5 reels layout, yields 32 combinations of possible wilds in view on 1 line). Using these figures each line in the configuration of the game is assigned an assigned price which ensures a pre-determined desired payout return so that cumulatively, multiple lines can be played together.

Certain embodiments of the present invention seek to provide a second method for computing the above data by exhaustively running through all possible reel outcome combinations for the wilds in view combinations and calculating a cost to play and payout return for that wild combination.

The methods may receive some or all of the following inputs:
reel layouts for all reels
payouts awarded for combinations of symbols appearing on lines, e.g. as per a conventional awarding system in which wins pay left to right
line layouts
Either the desired price or desired RTP for each of the 32 (say) cases per line or 32768 (say) permutations per 20 lines,
The output of each method also typically includes the desired price or desired RTP. One can either enter a desired price and be told what RTP this may yield or vice versa.

According to the first method, typically,
a. a return value is computed, representing how much money a player would get in return if they spun 1 unit stake, based on payouts being multiples of this 1 unit. The return value may be computed for spinning a 1 line slot machine, in 2 exp 5=32 ways (assuming 2 wild states (locked, unlocked) and 5 symbols per pay line) to account for all possible permutations of locking a wild on a single line.
b. The return values computed in (a) are used to compute prices that enforce a chosen RTP (return to player) and Casino Margin. For example if playing at 1 unit stake a player on average gets 4.75 units back, then charging players 5 units to play this game and paying out on 1 unit stake as before may yield a 95% RTP or 5% Casino Margin (4.75/5).
c. When a player changes a locked wild configuration, or when such changes occur through gameplay, a new total price is calculated by comparing each of the slot machine's pay lines (say: 20) with the 32 (say) permutations, retrieving their price and totaling. For example if 20 lines each costing 5 units were configured by a player or through gameplay then the cost to play, which would be presented to a user for his approval, would be 100 units.

According to the second method, typically,
a. The method cycles through all possible locked-wild states (e.g. 32,768 possible states given 5 reels and an in-view window 3 symbols high and given 2 wild states (locked, unlocked) by using a 15 bit binary number for example 000100100000100 which maps to one of the states. Total prices are computed for each state. The total prices for all possible states that the player may wish to play are sorted by the highest price vs, the lowest price and are stored.
b. A player is supported in selecting a lower priced locked wild state then the one currently chosen. 30 (say) options are presented, or some other number small enough to not overwhelm the player. These options are selected, typically to be evenly distributed within the states as stored which are lower than the current state. For example if there are 300 possible prices lower than the current state, every 10^{th} price may be presented to the user as an option, although the method also enforces a minimum separation in cost e.g. 0.01, so if stakes are the same price (e.g. to the penny), one is excluded,

Certain embodiments of the present invention seek to provide a Server operative to generate a pre-set displayable number, such as 30, of price options and associated wild states that are, say, lower than the current price and wild state thereby enabling a player or user to conveniently select a lower priced locked wild states than that currently in effect, since for every or various possible changes in wild state displayed to the player an associated (lower e.g.) price is also displayed.

Certain embodiments of the present invention seek to provide a Server operative for computing, for every possible wild state in the game (e.g. 32768 permutations in the illustrated embodiment), an associated price of each of these states and storing all of this information, e.g. in a list, in computer storage for convenient on-line reference during game play. The price for each of the (say) 20 pay-lines in the game may be computed based on the wild state that forms per line based on the overall wild layout (1 of the 32768 permutations). The wild state of each line may be 1 of 32 permutations (in the illustrated 5-reel embodiment). The price of each of these 32 permutations may be supplied to the server via a data set computed externally. The total cost of the wild state of the total in-view area (e.g. 3×5 symbols in the illustrated embodiment) is the sum of the costs of all the 20 win lines for this state. The server may compute the price of any wild state encountered on-line whether due to player selection or due to normal game play, by using the list (e.g.) in computer storage to compare against the current wild state and presenting this price to the player for his approval, as the cost of spinning with this wild state; given user approval, the wild state is spun i.e. all locked wilds are not virtually spun and all other symbols are spun,

Still another embodiment of the present invention provides a machine having: a plurality of reels, each reel having a plurality of indicators in a predetermined order on the reel and each reel being operable to spin and stop in a random or pseudo-random fashion, the stopped reels providing a number of lines of indicators; a window through which an array of the indicator lines on the stopped reels is visible; a processor to apply a set of rules to the location of the indicators in the array to determine an outcome category for the particular array of indicators; and an overlay indicator to be positioned at a selectable position in the array, wherein the overlay indicator remains in the selected position during the next spin of the reels and, after the reels stop, the overlay indicator in its selected position takes the place of the indicator in that position in the array such that the processor applies the set of rules to the location of the indicators in the array including the overlay indicator at its selected position.

A further embodiment of the present invention provides a machine having an array of indicators ordered as a result of a random or pseudo-random process, a processor to apply a set of rules to the location of the indicators in the array to determine an outcome category for the particular array of indicators, and an overlay indicator to be positioned at a selectable position in the array, wherein the overlay indicator remains in the selected position during a next random or pseudo-random ordering process and, after the ordering process, the overlay indicator in its selected position in the array takes the place of the indicator in that position in the array such that the processor applies the set of rules to the location of the indicators in the array including the overlay indicator at its selected position.

Example: there may be ten indicators per reel and five reels per machine. The window may restrict the array to a three-high (per reel) array of indicators.

There is thus provided, in accordance with at least one aspect of the present invention, a computerized reel-based game system comprising:

an array of indicators ordered as a result of a random or pseudorandom spin of a plurality of reels;

a processor adapted to apply a set of rules to the location of the indicators in the array to determine an outcome category corresponding to the particular array of indicators;

a user interface adapted to enable user-initiated positioning of at least one overlay indicator at a selectable position in the array, thus giving rise to a selected position;

a lock unit adapted, responsive to an actuation command, to replace an indicator to be positioned in the selected position resulting from a next random or pseudo-random spin of the reels by the at least one overlay indicator, wherein the processor is further adapted to apply the set of rules to the resulted array with the overlay indicator in the selected position; and

an actuation module adapted to calculate, responsive to the user-initiated positioning of the overlay indicator, a stake to be paid in accordance with the selected position and a cost associated therewith, to enable presenting the associated cost via the user interface and, responsive to the user's approval of the stake, to generate the actuation command and send it to the lock unit.

There is thus further provided, in accordance with at least one embodiment of the present invention, a system wherein the actuation module is operative for on-line generation of an associated cost to be debited to the user which enforces pre-learned constraints for a subset of reels to be locked which is determined on-line.

There is thus yet further provided, in accordance with at least one embodiment of the present invention, a system, wherein a positioning mechanism is provided to move the overlay indicator to a position selected by a user.

There is thus yet further provided, in accordance with at least one embodiment of the present invention, a system, wherein the position of the overlay indicator is registered with the processor.

There is thus yet further provided, in accordance with at least one embodiment of the present invention, a system, wherein after the random or pseudorandom ordering process the processor applies the set of rules to the location of the indicators in the array including the registered overlay indicator at its selected position,

There is thus yet further provided, in accordance with at least one embodiment of the present invention, a system wherein multiple overlay indicators are positioned at selectable positions in the array.

There is thus yet further provided, in accordance with at least one embodiment of the present invention, a system wherein a first and a second user initiator are provided to start the random or pseudo-random ordering process,

wherein the first user initiator starts the process without the overlay indicator registering its selected position in the array with the processor such that the processor applies the set of rules to the location of the indicators in the array excluding the overlay indicator at its selected position; and

the second user initiator starts the process with the overlay indicator registering its selected position in the array with the processor such that the processor applies the set of rules to the location of the indicators in the array including the overlay indicator at its selected position.

There is thus yet further provided, in accordance with at least one embodiment of the present invention, a system wherein the indicators are a set of symbols.

There is thus yet further provided, in accordance with at least one embodiment of the present invention, a system, wherein the overlay indicator is one of the set of symbols.

There is thus yet further provided, in accordance with at least one embodiment of the present invention, a system, wherein there is a base stake applied to use of the first user initiator; and the stake applied to use of the second user initiator is calculated by the processor based on the set of rules including the overlay indicator at its selected position.

There is thus yet further provided, in accordance with at least one embodiment of the present invention, a system wherein the positioning mechanism comprises a guide on which the overlay indicator is slideably mounted,

There is thus yet further provided, in accordance with at least one embodiment of the present invention, a system wherein the positioning mechanism comprises a user-controlled cursor.

There is thus yet further provided, in accordance with at least one embodiment of the present invention, a system wherein for at least one on-line selection of at least one wild to be locked, a return value is computed by the actuation module to indicate a monetary amount that a player would receive in return for spinning a 1 unit stake using a 1 line slot machine, based on payouts being multiples of the unit.

There is thus yet further provided, in accordance with at least one embodiment of the present invention, a system wherein there is a window offering a view of a selection of the indicators, the array of indicators,

There is thus yet further provided, in accordance with at least one embodiment of the present invention, a system wherein the return value is computed repeatedly by the actuation module, once for each possible permutation of locking a wild on a single line, thereby to yield a total of r return values, where r=2 exp s, where s=the number of symbols per line.

There is thus yet further provided, in accordance with at least one embodiment of the present invention, a system wherein the actuation module generates a component cost, enforcing pre-learned constraints, for each of the r return values, thereby to yield a total of r component cost values.

There is thus yet further provided, in accordance with at least one embodiment of the present invention, a system wherein the actuation module is operative for generating a total cost, enforcing the constraints, for at least one locked wild configuration, the generating comprising:

comparing each individual line from among a second plurality of lines with the possible permutations of locking a wild and identifying an individual matching permutation to match the individual line, thereby to define a second plurality of matching permutations; and

summing the component costs generated for each of the return values computed for each of the second plurality of matching permutations,

There is thus yet further provided, in accordance with at least one embodiment of the present invention, a system wherein the spin of the reels is operative in accordance with the on-line selection of at least one wild to be locked in that while the selection is in effect, each spin retains each such wild in the given one of the plurality of reels.

There is thus yet further provided, in accordance with at least one embodiment of the present invention, a system wherein the pre-learned constraints include at least one of a required RTP (return to player) level and a required Casino Margin.

There is thus yet further provided, in accordance with at least one embodiment of the present invention, a system wherein the user controlled cursor is operative to identify a position in the array to which the overlay indicator is moved after a user indication of a selected position.

There is thus yet further provided, in accordance with at least one aspect of the present invention, a computerized gambling method for providing a computerized reel-based game system having a first plurality of reels and defining a second plurality of pay lines, the method including:

providing a user interface having an on-line lock-and-spin input option determining, repeatedly and for each user, an on-line selection of at least one wild to be locked in a given one of the plurality of reels;

providing a locking module operative to lock a subset, deter mined on-line by the user interface, of the first plurality of reels;

providing a spinning module operative, responsive to an actuation signal, to virtually spin the first plurality of reels other than as locked by the locking module; and
providing an actuation module operative to control said on-line lock-and-spin input option by generating on-line, for at least one on-line selection of at least one wild to be locked, an associated cost to be debited to the user which enforces pre-learned constraints given the subset, causing the user interface to present the associated cost to the user on-line, and responsive to the user's on-line approval of the associated cost, to generate the actuation signal.

There is thus yet further provided, in accordance with at least one embodiment of the present invention, a method wherein the user interface is operative to accept an on-line user selection of at least one wild to be locked and responsively, to present to the user a cost associated with the on-line user selection, and wherein the actuation module is operative to receive the on-line user selection of at least one wild to be locked in a given one of the plurality of reels and to generate, accordingly, a cost associated with the on-line user selection, for presentation to the user.

There is thus yet further provided, in accordance with at least one embodiment of the present invention, a method wherein the pre-learned constraints include at least one of: a required RTP (return to player) level; and a required Casino Margin.

There is thus yet further provided, in accordance with at least one embodiment of the present invention, a method wherein for at least one on-line selection of at least one wild to be locked, a return value is computed indicating a monetary amount that a player would receive in return for spinning a 1 unit stake using a 1 line slot machine, based on payouts being multiples of the unit.

There is thus yet further provided, in accordance with at least one embodiment of the present invention, a method wherein the return value is computed repeatedly, once for each possible permutation of locking a wild on a single line, thereby to yield a total of r return values, where r=2 exp s, where s=the number of symbols per line.

There is thus yet further provided, in accordance with at least one embodiment of the present invention, a method wherein the actuation module generates a component cost, enforcing the pre-learned constraints, for each of the r return values, thereby to yield a total of r component cost values.

There is thus yet further provided, in accordance with at least one embodiment of the present invention, a method wherein the actuation module is operative for generating a total cost, enforcing the constraints, for at least one locked wild configuration, the generating comprising:

comparing each individual line from among a second plurality of lines with the possible permutations of locking a wild and identifying an individual matching permutation to match the individual line, thereby to define a second plurality of matching permutations; and

summing the component costs generated for each of the return values computed for each of the second plurality of matching permutations.

There is thus yet further provided, in accordance with at least one embodiment of the present invention, a method, wherein the spinning module is operative in accordance with the on-line selection of at least one wild to be locked in that while the selection is in effect, each spin retains each such wild in the given one of the plurality of reels.

There is thus yet further provided, in accordance with at least one embodiment of the present invention, a method, wherein the reels comprise virtual reels.

There is thus yet further provided, in accordance with at least one embodiment of the present invention, a method wherein, for a given game, the actuation module is operative to provide a Pricing level which is expressed in terms of a predetermined base stake level used to play spins in an otherwise identical game that do not support dynamic lock-and-spin operations, thereby to ease adaptation to any on-line changes a player makes to his base stake.

There is thus yet further provided, in accordance with at least one embodiment of the present invention, a method wherein the actuation module is operative to generate on-line, and present to the user, a stake level which adjusts relative to the increased average win amount for a current user-selected configuration of wilds.

There is thus yet further provided, in accordance with at least one embodiment of the present invention, a method wherein, for a given game, the actuation module is operative to maintain a pay-out ratio that matches the ratio of playing the game such that wilds are not added and spins are played at base stake level.

There is thus yet further provided, in accordance with at least one embodiment of the present invention, a method wherein a final cost parameter is computed by the actuation module by multiplying a stored cost by a current base stake that the user has set in the game, each time a cost is displayed to the player for his on-line approval for Lock & spin.

Also provided, excluding signals, is a computer program comprising computer program code means for performing any of the methods shown and described herein when said program is run on a computer; and a computer program product, comprising a typically non-transitory computer-usable or -readable medium e.g. non-transitory computer-usable or -readable storage medium, typically tangible, having a computer readable program code embodied therein, said computer readable program code adapted to be executed to implement any or all of the methods shown and described herein. It is appreciated that any or all of the computational steps shown and described herein may be computer-implemented. The operations in accordance with the teachings herein may be performed by a computer specially constructed for the desired purposes or by a general purpose computer specially configured for the desired purpose by a computer program stored in a typically non-transitory computer readable storage medium.

Any suitable processor, display and input means may be used to process, display e.g. on a computer screen or other computer output device, store, and accept information such as information used by or generated by any of the methods and apparatus shown and described herein; the above processor, display and input means including computer programs, in accordance with some or all of the embodiments of the present invention. Any or all functionalities of the invention shown and described herein, such as but not limited to steps of flowcharts, may be performed by a conventional personal computer processor, workstation or other programmable device or computer or electronic computing device or processor, either general-purpose or specifically constructed, used for processing; a computer display screen and/or printer and/or speaker for displaying; machine-readable memory such as optical disks, CDROMs, magnetic-optical discs or other discs; RAMs, ROMs, EPROMs, EEPROMs, magnetic or optical or other cards, for storing, and keyboard or mouse for accepting. The term “process” as used above is intended to include any type of computation or manipulation or transformation of data represented as physical, e.g. electronic, phenomena which may occur or reside e.g. within registers and /or memories of a computer or processor. The term processor includes a single processing unit or a plurality of distributed or remote such units.

The above devices may communicate via any conventional wired or wireless digital communication means, e.g. via a wired or cellular telephone network or a computer network such as the Internet.

The apparatus of the present invention may include, according to certain embodiments of the invention, machine readable memory containing or otherwise storing a program of instructions which, when executed by the machine, implements some or all of the apparatus, methods, features and functionalities of the invention shown and described herein. Alternatively or in addition, the apparatus of the present invention may include, according to certain embodiments of the invention, a program as above which may be written in any conventional programming language, and optionally a machine for executing the program such as but not limited to a general purpose computer which may optionally be configured or activated in accordance with the teachings of the present invention. Any of the teachings incorporated herein may wherever suitable, operate on signals representative of physical objects or substances.

The embodiments referred to above, and other embodiments, are described in detail in the next section.

Any trademark occurring in the text or drawings is the property of its owner and occurs herein merely to explain or illustrate one example of how an embodiment of the invention may be implemented.

Unless specifically stated otherwise, as apparent from the following discussions, it is appreciated that throughout the specification discussions, utilizing terms such as, “processing”, “computing”, “estimating”, “selecting”, “ranking”, “grading”, “calculating”, “determining”, “generating”, “reassessing”, “classifying”, “generating”, “producing”, “stereo-matching”, “registering”, “detecting”, “associating”, “superimposing”, “obtaining” or the like, refer to the action and/or processes of a computer or computing system, or processor or similar electronic computing device, that manipulate and/or transform data represented as physical, such as electronic, quantities within the computing system's registers and/or memories, into other data similarly represented as physical quantities within the computing system's memories, registers or other such information storage, transmission or display devices. The term “computer” should be broadly construed to cover any kind of electronic device with data processing capabilities, including, by way of non-limiting example, personal computers, servers, computing system, communication devices, processors (e.g. digital signal processor (DSP), microcontrollers, field programmable gate array (FPGA), application specific integrated circuit (ASIC), etc.) and other electronic computing devices.

The present invention may be described, merely for clarity, in terms of terminology specific to particular programming languages, operating systems, browsers, system versions, individual products, and the like. It will be appreciated that this terminology is intended to convey general principles of operation clearly and briefly, by way of example, and is not intended to limit the scope of the invention to any particular programming language, operating system, browser, system version, or individual product.

Elements separately listed herein need not be distinct components and alternatively may be the same structure.

Any suitable input device, such as but not limited to a sensor, may be used to generate or otherwise provide information received by the apparatus and methods shown and described herein. Any suitable output device or display may be used to display or output information generated by the apparatus and methods shown and described herein. Any suitable processor may be employed to compute or generate information as described herein e.g. by providing one or more modules in the processor to perform functionalities described herein. Any suitable computerized data storage e.g. computer memory may be used to store information received by or generated by the systems shown and described herein. Functionalities shown and described herein may be divided between a server computer and a plurality of client computers. These or any other computerized components shown and described herein may communicate between themselves via a suitable computer network.

### BRIEF DESCRIPTION OF THE DRAWINGS

Certain embodiments of the present invention are illustrated in the following drawings:

FIG. 1 is a schematic prior art block diagram of a conventional slot machine.

FIG. 2 is a simplified block diagram illustration of a computerized reel-based game system constructed and operative in accordance with certain embodiments of the present invention.

FIG. 3 is a schematic block diagram of a machine exemplifying one embodiment of the present invention.

FIGS. 4-7 are tables useful in understanding an example William-Hill embodiment of the present invention, it being appreciated that the William-Hill implementation is provided merely by way of example; if an alternative to William-Hill is employed as is well known in the art, then the implementation would differ mutatis mutandis depending on the alternative selected.

FIG. 8 is a simplified diagram of a method for controlling a computerized reel-based game system constructed and operative according to an embodiment of the present invention, optionally in conjunction with the machines and systems of FIGS. 1-3.

FIG. 9 is another example table useful in understanding various embodiments of the present invention.

Each table shown herein may include some or all of the fields and/or records shown herein.

Computational components described and illustrated herein can be implemented in various forms, for example, as hardware circuits such as but not limited to custom VLSI circuits or gate arrays or programmable hardware devices such as but not limited to FPGAs, or as software program code stored on at least one tangible or intangible computer readable medium and executable by at least one processor, or any suitable combination thereof. A specific functional component may be formed by one particular sequence of software code, or by a plurality of such, which collectively act or behave or act as described herein with reference to the functional component in question. For example, the component may be distributed over several code sequences such as but not limited to objects, procedures, functions, routines and programs and may originate from several computer files which typically operate synergistically.

Data can be stored on one or more tangible or intangible computer readable media stored at one or more different locations, different network nodes or different storage devices at a single node or location.

It is appreciated that any computer data storage technology, including any type of storage or memory and any type of computer components and recording media that retain digital data used for computing for an interval of time, and any type of information retention technology may be used to store the various data provided and employed herein. Suitable computer data storage or information retention apparatus may include apparatus which is primary, secondary, tertiary or off-line; which is of any type or level or amount or category of volatility, differentiation, mutability, accessibility, addressability, capacity, performance and energy use; and which is based on any suitable technologies such as semiconductor, magnetic, optical, paper and others.

### DETAILED DESCRIPTION OF CERTAIN EMBODIMENTS

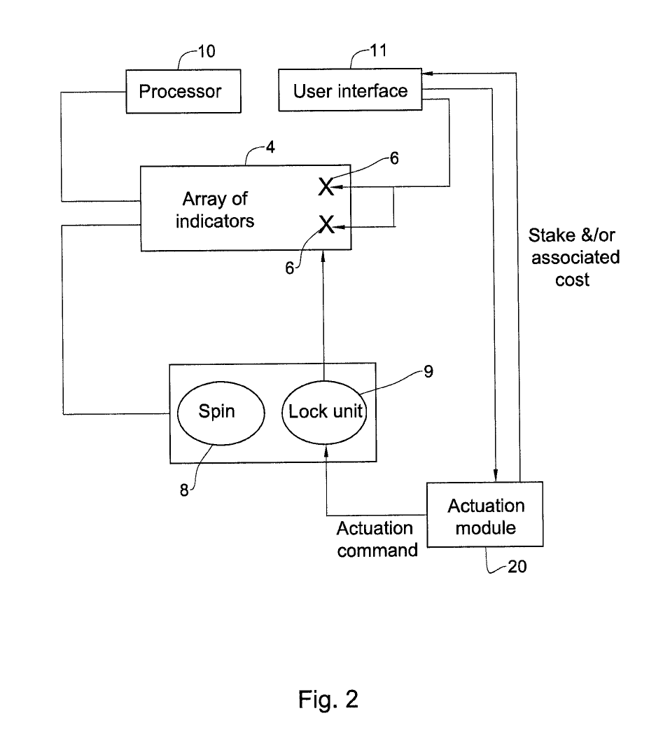

FIG. 2 is a simplified block diagram illustration of a computerized reel-based game system in accordance with certain embodiments of the present invention. The computerized reel-based game system of FIG. 2 typically comprises some or all of the following:

An array of indicators 4 is typically ordered as a result of a random or pseudorandom spin of a plurality of reels. A processor 10 is adapted to apply a set of rules to the location of the indicators 4 in the array to determine an outcome category typically corresponding to or represented by the particular array of indicators. A user interface 11 is adapted to enable user-initiated positioning of at least one overlay indicator at a selectable position in the array, thus giving rise to a selected position. A lock unit 9 is adapted, responsive to an actuation command, to replace an individual one of the indicators 4 to be positioned in the selected position resulting from a next random or pseudo-random spin of the reels by an overlay indicator 6. The processor 10 is typically operative to apply the set of rules to the resulting array given that the overlay indicator 6 is in the selected position. Also provided is an actuation module adapted to calculate, responsive to said user-initiated positioning of the overlay indicator 6, a stake to be paid in accordance with the selected position and a cost associated therewith. The associated cost is presented to the user via the user interface and, responsive to the user's approval of the stake, then generates the actuation command which is sent to hence actuates the lock unit 9.

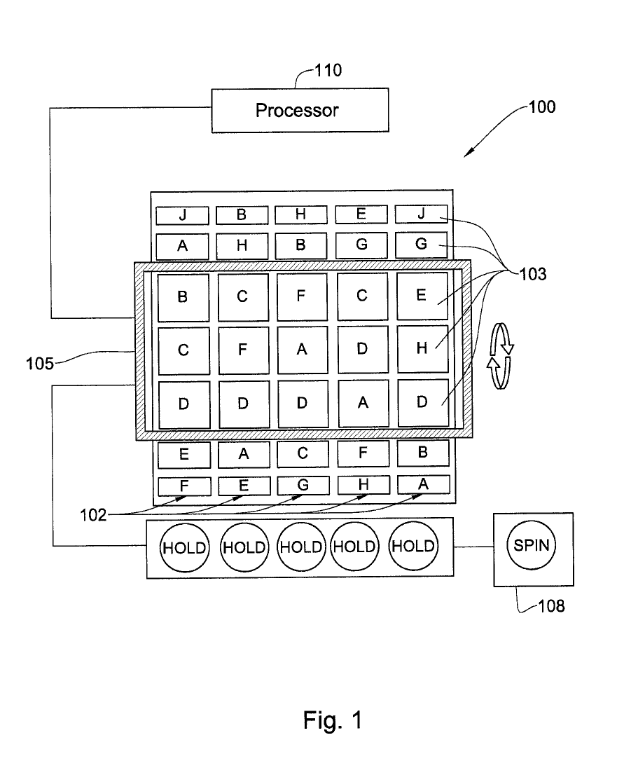

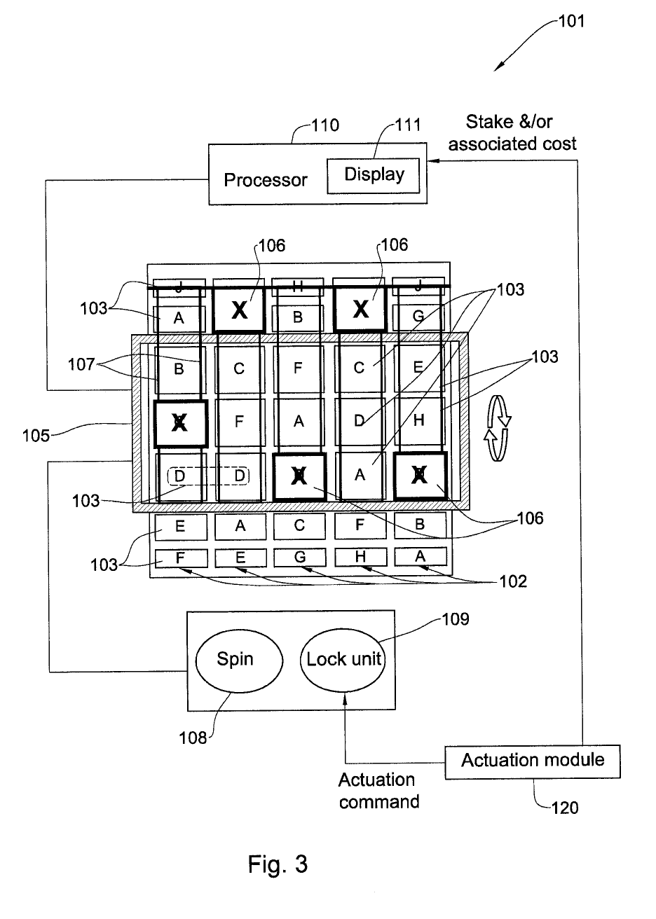

Various embodiments of the system of FIG. 1, and variations thereupon, are now described. The example embodiment of FIG. 3 is now first described in detail. The system 101 of FIG. 3 may include any or all of the features of a conventional machine 100 of the type illustrated in FIG. 1 e.g. a plurality of reels 102, each reel 102 having a plurality of indicators 103 or symbols in a predetermined order around the reel 102. Each reel 102 may be operable to spin and stop in a random or pseudo-random fashion. In one example, there may be ten symbols 103 per reel 102 and five reels 102.

After each spin, the stopped reels 102 present an array, typically comprising a number of lines 104, of indicators or symbols. These lines may be a random or pseudo-random outcome of the spinning and stopping process. The lines 104 may run from left to right and follow a continuous pathway across the indicators. Line 104 in FIG. 3 may be a “five-of-a-kind” line of the indicator “D” including two wilds and three “D” indicators 3.

A window 5 in the machine 1 offers a view of an example array of indicator lines. The window 105 offers a view of a limited number of lines and defines or makes up the array. In the example of FIG. 3, the window 105 restricts the array to a five by-three array of symbols 103.

The machine 101 includes a processor 110 to determine whether the symbols 103 making up the array may be arranged in lines which represent a particular outcome. The outcome may for example be a winning outcome, a losing outcome or an outcome where the stake is returned. Winning outcomes may pay out an amount determined by the processor 110 in response to a stake indicated by a user, the location of any wilds and the location of the other indicators in the array. Thus, there are a number of potential outcomes and outcome categories. It is appreciated that neither of these are limited to those specifically shown described or implied herein merely by way of example.

Referring to FIG. 3, an embodiment 101 of the present invention further comprises an overlay indicator 106 which can be positioned at a selectable location over or on the array in the window 105. Multiple overlay indicators 106 are possible (and shown in FIG. 3) but for the sake of simplicity, the present discussion refers to a single overlay indicator on a single reel 102. The single overlay indicator 106 can be positioned at any position in the array selectable by the user (or potentially randomly assigned on user request). The use of an overlay indicator 106 if provided is typically controlled by a user. Typically, the symbols 106 at the very top of the screen (above the viewable area) exist on the reels and are not user selectable.

The indicators 103 used by the machine of FIG. 3 may for example comprise any suitable set of symbols. The overlay indicator 106 may itself be one of the set of symbols or may be a modified version of one of the set of symbols such as an icon of a caged animal, if the original symbol is the same animal shown uncaged.

A positioning mechanism 107 may be provided to move the overlay indicator 106 to a position selected by a user. The overlay indicators 106 may be slideable tablets 106 mounted on a guide 107 such as rails 107 spanning the window 105. The tablets 106 can be positioned over a respective array location and the machine 101 registers the position of the tablet in the array with the processor 110. The position of the overlay indicator 106 may be thus registered with the processor 110. The reels 102 may be free to rotate under the or each tablet 106 e.g. in their normal spinning mode. The tablet or overlay indicator 106 remains in the user-selected position during the next spin of the reels 102.

If the machine is configured with an electronic display of the window 105, then the positioning mechanism 107 comprises a user-controlled cursor to identify a position in the array to which the overlay indicator 106 may be moved after a user indication of a selected position.

A first and/or a second user initiator may be provided to start the random or pseudorandom ordering process. The first initiator 108 may be a “spin” button and the second initiator 109 may be a “lock and spin” button. When the user selects the first user initiator 108, the process may be started without the overlay indicator 106 confirming the registration of its selected position in the array with the processor 110. Any provisional positioning of the overlay indicator 106 may be ignored by the machine 101. Thus, the processor 110 applies the set of rules to the location of the indicators 103 in the array excluding the overlay indicator 106 at its selected position. If the user selects the second user initiator 109, then the process may be started with the overlay indicator 106 confirming the registration of its selected position in the array with the processor 110. The provisional positioning of the overlay indicator 106 may be confirmed by the machine 101 and the processor 110 applies the set of rules to the location of the indicators 106, 103 in the array, this time including the overlay indicator 106 at its selected position.

In some embodiments, there may be a base stake applied to use upon selection of the first user initiator (the “spin” button) 108; and the stake applied to use of the second user initiator (the “lock and spin” button) 109 may be calculated by the processor 110 based on the set of rules including the overlay indicator 106 at its selected position.

After the reels 102 stop, i.e. after the random or pseudo-random ordering process, the processor 110 applies the set of rules to the location of the indicators 106, 103 in the array including any confirmed registered overlay indicator 106 at its selected position if the “lock and spin” button was pressed. In this way, the processor 110 applies the set of rules to the symbols 106, 103 in the array including the overlay indicator 106 at its user-selected and processor registered position in place of the symbol underlying the overlay indicator 106. The processor 110 determines the outcome category of this particular process on the basis of the symbols 106, 103 in the array and any overlay indicator 106 at a position in the array.

After the spin, the machine 110 displays the overlay indicator 106 at the position of the underlying indicator on the reel 102. In one embodiment, the overlay indicator 106 may be opaque so the underlying indicator is not viewable. In another embodiment, the overlay indicator 106 may be at least partially transparent so the identity of the underlying indicator is viewable by the user. In this embodiment, the user can see the identity of the indicator 103 at the position which has been replaced by the overlay indicator 106.

In the following discussion of embodiments 101 of the present invention, the process of selecting a position in the array for an overlay indicator (tablet) 6 is referred to as “locking a wild”. If a wild is locked, then the guaranteed presence of a wild in one or more of the lines in the array increases the chances of a winning outcome. The user has reduced the winning odds so the stake payable by the user is commensurately increased. Effectively, a user pays extra to deploy an overlay indicator or to “lock a wild”.

In addition to being able to specify a wild at a particular location on the array for the next spin, the machine 101 also recognizes if a wild symbol on one of the reels 102 appears in the array, without having been pre-specified by the user, i.e. by chance. A user can lock that wild in place in that position. This may be effected by the user locating an overlay indicator 106 over the wild symbol in the array 105. The presence of a wild at the specified position may be registered to the processor 110. The wild may be locked and the stakes adjusted accordingly.

When an overlay indicator 106 may be deployed on the array 105, the stakes applicable with the newly deployed wild may be calculated by the processor 110 in response to the number and respective locations in the array of the overlay indicators being registered with the processor. Preferably the calculated stake value may be displayed by the machine 110 on a display 111 which also provides other game information such as credit, number of spins remaining, number of wilds locked, history and calculated stake value for the following spin.

The display 111 may be configured as a separate display to the window 5 showing the array of indicator lines as in FIG. 3, or it may be configured as a composite display to include display 111 in the window 105 or around the window 105.

According to one embodiment, the machine 101 has either or both of two “start” buttons: a “spin” button and a “lock and spin” button. The “spin” button 108 can be depressed at no extra cost or stake and no wilds may be locked. Pressing the “lock and spin” button 109 (or otherwise actuating that functionality e.g. as described herein) locks any selected wilds in place by confirming registration of any overlay indicators 106 with their location on the array.

If any overlay indicators 106 may be indicated or deployed but only the “spin” button 108 is pressed, then the overlay indicators 106 may be disregarded by the processor 110 since the user has not confirmed or committed to the higher stake calculated as due if the wilds were locked. Pressing the “spin” button 108 effectively unlocks any deployed wilds (not confirming them) and a normal spin process ensues without any user-specified wilds being recognized.

There may be an “auto-lock” mode in which any naturally occurring wilds may be “locked”. When “auto-lock” mode is disabled, “lock and spin” may only lock the user-selected wilds.

The cost of a normal spin may be: stake per line x number of lines but the cost of the lock & spin option may vary depending on the position of the wilds.

Wins may be paid from left to right and may be multiplied by the stake per line. In example embodiments, there are 20 win lines available (e.g. fixed—not selectable).

Wild symbols can substitute for other symbols to help create a line win. 5 wilds on a win line can also award a payout (the highest payout in the game). The user has an option to keep all wilds for the next spin or a custom selection of wilds they would like to keep. There may be an alternate stake that represents the cost of the spin based on the wilds they have selected.

During freespins, if provided, wilds that appear may automatically be locked and carried forward to the next spin. This is regardless of whether free spins were activated during a normal or “lock and spin”.

Spin Modes: There may be provided some or all of the following 3 types of spin that can be achieved through 2 spin buttons. The spin types are described below.
Normal Spin: Standard spin mode where all reels are spun and no wilds are locked/kept. This mode may be chosen whenever the user clicks the ‘Spin’ button. The cost of this may be the line stake multiplied by the line count (20, fixed in this case).
Lock & Spin with Auto Lock On: The second spin button performs a ‘lock & spin’ mode where all wilds that are visible on the reels are locked and held in to the next spin. The wilds may have a graphic, e.g. black padlock, depicting that the wild may be locked when the “Lock & Spin” button is pressed, the wild may then be held over the reels whilst the reels spin behind it, the wilds can then help to form line wins. Each wild may stay locked indefinitely until it is unlocked manually by the user or the “Spin” button may be pressed instead of Lock & Spin.

The cost of this mode may be determined by individually calculating the price for each line. The total cost calculated for all 20 lines may give a total stake for spinning with all the wilds locked. The number and positions of the wilds on the reels may influence the total cost of the spin. This extra spin cost may be provided as a second stake amount above the ‘lock & spin’ button.
Lock & Spin with Auto Lock Off: The user can select (within the options, and on initial press of the “Lock & Spin” button) to play with Auto Lock turned off In the case where the arrays are electronically displayed as opposed to a mechanical or electro-mechanical arrangement, the wilds may have a red padlock graphic depicting that the mode is not the standard Auto Lock on mode. When “Lock & Spin” is played during this mode only the wilds with the red padlocks (those that existed when Auto Lock was turned off, or those manually selected by the user) may be locked, all other wilds may not be locked.

The cost per spin in this mode may be determined by calculating the price for each line but this time taking into account only wilds which may be locked.
Changing the locked wilds—editing current wilds: This feature gives the user a choice of which positions they would like to lock. In the case where the arrays are electronically displayed as opposed to a mechanical or electro-mechanical arrangement, the user toggles which wilds they wish to lock for the spin by moving the mouse over any symbol.
Moving the mouse over a symbol may be denoted graphically e.g. may cause a gold border to animate. This symbol can then be clicked. Clicking the symbol may change the symbol into a wild symbol. Hovering the mouse anywhere on the reels may produce a padlock symbol in the top right hand corner for all wilds that may be locked.
The user can click on a wild symbol that is due to be locked to remove it, and it may be replaced with a default ‘10’ symbol.
Cycling through different stakes: The user can use the up and down arrows to the right of the Lock & Spin stake box to easily adjust the cost of the stake needed to lock the wilds. This may automatically change which wilds may be locked/unlocked to offer the stake of the value shown.
Note that when there are several wilds on screen then there may be thousands of different stakes and wild positions that are available, but only some of those may be in this list, so users do not need to press down several thousand times to reduce the stake to a smaller value.
All possible combinations can be achieved by manually editing the current wilds as mentioned above.
Adding new wilds: It may be possible to add a new wild by simply clicking on one of the symbols that was not already a wild or in the mechanical/electro-mechanical embodiments by simply overlaying a tablet. This may then change the overlaid symbol with a locked wild for the next Lock & Spin and adjust the cost accordingly. It may be possible to lock every symbol on the reels if the user wishes (but the cost of this may be very high and more than the amount they win—unless they trigger freespins).
Keeping current wild layout: There may be an option in the game that can keep a favourite wild array layout “locked in place”. On the first lock and spin a player has the option to ‘disable auto lock wilds’ and to turn off Auto Lock. This means any wilds that are currently in place may receive red padlocks. A player can lock and spin after that and any additional new wilds would *not* lock in place.
This mode may be for a power user that, like a roulette user, might have a special pattern (array) of bets that they continuously want to use. Using this option would save a player having to de-select any new wilds that have appeared on the lock and spins.
This option can be toggled on and off from within the game options menu and also by editing the current wilds oneself as mentioned above.
Bonus Activation: Optionally, these embodiments of the machine only have a freespins feature and does not have a separate bonus or progressive. It is appreciated that any type of bonus game, or none, may be implemented in a game that includes a lock and spin functionality with dynamic pricing functionality as shown and described herein.
Freespins may be triggered, for example, by acquiring all of 5 predetermined letters.
The letters may be reset after each spin. No letters appear during freespins.
As with the normal game all wins may be paid out based on the stake per line value (not the actual amount the user paid to lock the wilds).
Freespins may use a separate reelset to the main game but the payouts may be the same for each symbol.

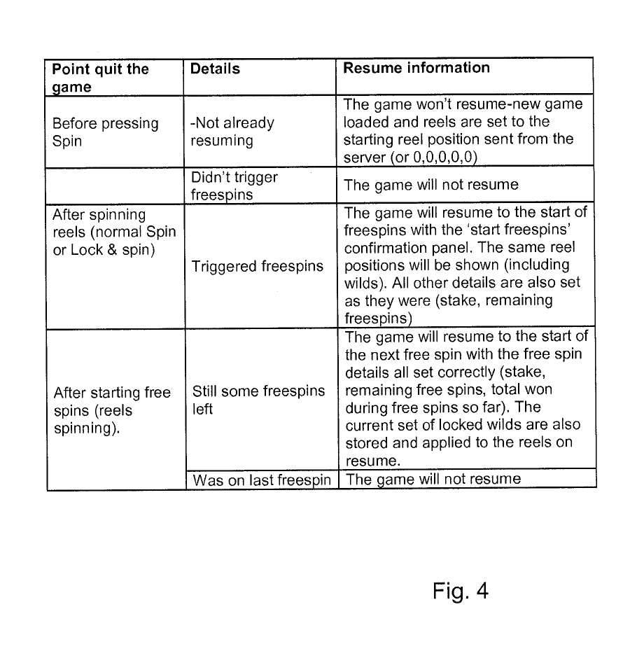

If the user quits in the middle of a game then the point the game resumes to (or if it resumes at all) depends on the part of the game they were in. An example of this computerized scheduling is described in the Resume points table of FIG. 4, some or all of which may be provided.

Flash shared objects (Cookies) may be used to allow the user to save and load their favorite wild layout (which of the 15 symbols are selected as locked wilds). This means that if a user always plays with certain symbols selected as wild then they can select those and then save the layout in the options menu and those wilds may be selected by default the next time they load the game. They can also load their saved layout in the options menu (in case they have selected other wilds or cleared them since starting the game). By default the last wild layout used may be loaded.
Using Spacebar to spin: The space bar on the keyboard may be enabled so it can beused to spin rather than needing to click on the Spin button. This is so that the user can easily spin again and again. Typically, this will only do a normal Spin, not a Lock & Spin. This functionality may be only enabled at the same times the Spin button is clickable (so not when in the paytable screen or options menu). Other keyboard buttons may similarly have functions in the game if desired.
Auto Play: Auto Play, an optional feature, plays the game automatically for a set number of goes which the user sets at the start (e.g. Either 5, 10, 20, 50, 99 or “Until Bonus” Autoplays). The game then continues until it has played the selected number of spins (or the user stops the Auto Play). It may then go back to playing as normal. Auto Play only plays the Normal Spin, it does not do Lock & Spin. Auto Play may stop if the user does not have sufficient funds to repeat the bet. It may also stop if they get to one of the features in the game. Auto Play does not carry on once the bonus/feature is finished. Auto Play does not have any effect on the server/communications—it is just a front-end client setting,
Reel Symbols: A hierarchy of reel symbols (from highest to lowest) each having a symbol ID may be provided. For example, a set of icons including, say, icons of a lion, rhino, zebra, letter A, letter Q, number 10, cheetah, flamingo, letter K and letter J may be given symbol names or IDs of 10, 8, 6, 4, 2, 0, 7, 5, 3, 1 respectively. It is appreciated that the number of visible symbols depends on the size of the “visible window” which may e.g. comprise 3 symbols for each of 5 reels. When a user identifies a position in the array for a wild and wishes to lock the wild and register the wild position with the processor, the user may position the tablet over the relevant symbol in the desired position and that position may be registered with the processor. In embodiments of the invention where the display is configured electronically, a mouse click on the desired symbol position to be designated as a wild may be employed to lock the wild and register the wild position prior to selecting the lock and spin elevated stake and spinning the reels. The locked wild (which may be represented, say, using a caged animal icon) may be treated as a normal wild (which may be represented, say, using an uncaged animal icon) appearing in that position.

Optionally, a maximum total stake can be placed on any one game in the normal spin mode. In Lock & Spin the maximum stake may be, say, more than 1000 times this value if all the symbols are locked (however this may have a very large win guaranteed so the user may win most of their money back).

Payout statistics example: The overall RTP for a game may be 97.0%, 82.3% for the base game and 14.7% for the bonus freespins (when no wilds have been selected at start). Selecting Wilds may change the distribution of the RTP between base game and freespins but the overall RTP may remain at 97% for all combinations of wilds.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

Another example implementation of the system of FIG. 2 is now described. This is an example of a Multi-line (e.g. 20 pay line) slot with (say) 5 reels, freespins, and wilds that can be locked if the player decides to pay extra. The terms “win line” and “pay line” are used herein generally interchangeably.
Each press of start may cause the reels to spin to a random position.
There are 2 spin buttons “Spin” (which does a normal spin with no wilds held) and “Lock & Spin” (which keeps the wilds that are locked and then spins).
The cost of the normal spin may always be the same (stake per line×number of lines), but the cost of the Lock & spin may vary depending on the position of the wilds.
Wins may be paid from left to right and are multiplied by the stake per line.
There may be, say, 20 win lines available (fixed—not selectable).
There is a Wild symbol which can substitute for other symbols to help create a line win. 5 wilds on a win line can also award a payout (the highest payout in the game).
Wild symbols only count towards line wins—they do not count towards bonus scatters.
The player has an option to keep all wilds for the next spin or a custom selection of wilds they would like to keep. There is an alternate stake that represents the cost of the spin based on the wilds they have selected.
During freespins, wilds that appear may automatically be locked and carried forward to the next spin.

Some or all of the 3 types of spin described above may be provided and may be initially activated e.g. through 2 spin buttons.

Changing locked wilds may be supported e.g. as described above, optionally including some or all of: editing current wilds, cycling through different stakes, adding new wilds, and bonus Activation, and a Call of the Wild ‘Free Spins’ feature.

The results for the reels in both normal play and freespins may be decided by picking a random stop position on each reel (so getting a random number between 0 and 1 less than the number of symbols on that reel). Entry to the freespins bonus round may be decided by a random number that is separate to the reels. There is a weightings array that contains pre-selected weightings for showing, say, 0, 1,2,3,4 or 5 of the letters towards the bonus entry. A random number is chosen between 1 and the total of these weightings and then used with the weightings to work out how many letters the player should get. If they get 5 then they get to the freespins bonus.

The cost to lock the wilds is calculated by looping through each of the 20 winlines and getting a cost for the wilds on that line. There are 32 different combinations of wilds possible on each line (ranging from no wilds, to all 5 wilds). Each of these 32 different cases has a cost associated with it. After going through each of the 20 lines and getting the cost for the wild case on that line then these are all added together. This value is then multiplied by the stake per line and number of lines.

Resume Details may be as described above e.g. as per FIG. 4.
When the computerized game resumes it may employ some or all of the details described in the resume table above, e.g. the following data:

The point of the game to resume to

The selected stake

The previous reel positions (and win details)

The positions they selected to be locked.
When resuming to Freespins the computerized game may also utilize the following saved data:

The number of freespins remaining

The total amount won from the current set of freespins so far

Saving and Loading Wild Layout using cookies may be provided, e.g. as described above.
A “Using Spacebar to spin” feature may be provided, e.g. as described above.
AutoPlay may be provided, e.g. as described above.

Any suitable hierarchy of the reel symbols (from highest to lowest) and symbol IDs may be employed e.g. as described elsewhere herein by way of example. The symbol of a wild, once locked, may change to denote both its locked status (e.g. a cage or an x or a padlock) and the original symbol.
The available stakes are sent from the server and so can be adjusted as suitable to reflect suggested values for the stake per line (typically in currency units e.g. GBP), say 20 pence for a 1 penny stake per line, 40 pence for a 2 penny stake per line and so forth.

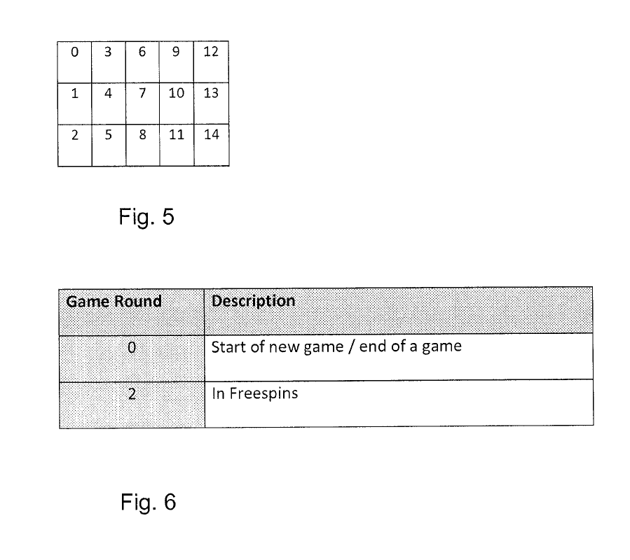

An example of a suitable Server Configuration is now described in detail. The description below assumes that the positions on the reels are numbered as per FIG. 5 and is suited to the game described above by way of example. The server configuration may be modified in any suitable manner, as known in the art and as would readily occur to the ordinarily skilled man of the art for different game applications with different rules.

A variable called gameRound may be used in the server communications, e.g. as per the table of FIG. 6, to keep track of which part of the game is being played and which part the game may go back to when it resumes.

Typically, the server may always check the correct request is sent at the correct time (so game doesn't send freespin request when not in freespins). Typically, if the game round is 0 then the state is not saved (it is cleared so reel positions etc. are not remembered).

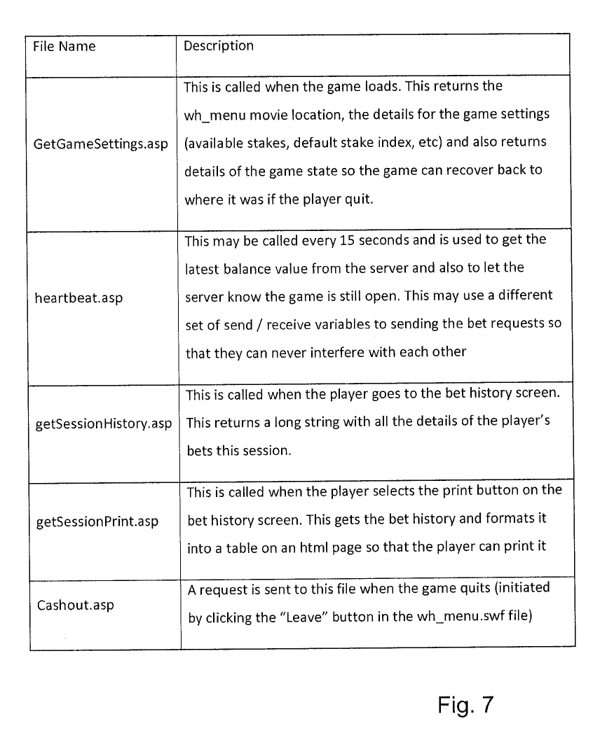

Server communications between server and client may include, similar to previous arcade games, game requests are sent to a placebet.asp file with the details of those requests (e.g. bet amount, action etc). The game may also make other requests, such as but not limited to some or all of those shown in the table of FIG. 7.

When the game loads, it may send a Game settings request to the server straight away by calling the “getGameSettings.asp” file (typically, no data needs to be sent). The server may then get the settings for the game and check if there is a game to be resumed. If so, the server may return the details for the game to be resumed as well.

Example: This file may then return some or all of the following:
Generic Details such as but not limited to some or all of:
   The URL for the William hill exit menu
   The URL for the help page
   The URL for the Cashier page
Game Specific details such as but not limited to some or all of:
   The available stake sizes
   The default stake index (or the index last used if resuming)
   The number of lines selected (may always be 20 for this game as fixed)
   Currency code for the currency the player is playing in
   The reel bands for normal play
   The reel bands for freeplay
   The winline details (formatted so each is 0,1,2 to say how far down each reel symbol is)
   The balance the player has in this game
   Any resume data

The server may check the state for the game for that player. If there is some state information, the server may check that this is for the current game, and if the state information is for the current game, then the server may return that information back to the game.

If the state information is for a different game (game code is not correct for this game) then the getGameSettings file may return an error to the game as follows: &errorStr=“State information was not for this game. Please call customer services”. The game may then display this error message to the player with an OK button and when that is pressed the game may close. (This error should never happen but this check is included just in case something goes wrong).
If the game is OK, some or all of the following resume data may be returned to the game:

gameRound (so game knows which part to return to)

Last Reel positions

Total Winnings for last reel position

Win string details for last position

List of position of wild symbols in last reel position

Total winnings so far from the freespins

Number of freespins remaining
Example: If the player was not resuming, then the data would be similar to this (so using default values for stake index and number of lines):

&delim=|&whMenuURL=../menu/wh_menu_9.swf&helpURL=instruct.html&cashier
URL=https://accounts.williamhill.com/acc/EN?action=GoDeposit&stakes=0.01|0.02|
0.03|0.04|0.05|0.06|0.07|0.08|0.09|0.1|0.11|0.12|0.15|0.2|0.25|0.3|0.4|0.5|0.75|1|2|3|5|7.
5|10&balance=99977556.68&currCode=GBP&gameRound=0&stakeIndex=9&stake
Value=0.1&minWinLines=20&maxWinLines=20&numWinLines=20&normalReels=
8,2,1,6,3,2,5,0,1,7,0,1,8,2,3,6,1,0,5,3,0,6,3,1,7,0,4,8,1,0,5,2,0,4,3,0,2,4,3,2,4,6,8,10,7,
5,4,2,7,0,1|0,4,5,7,10,8,6,4,1,8,3,2,7,1,0,5,3,1,6,2,0,5,2,0,6,1,4,7,0,2,8,0,1,8,2,3,6,1,0,
7,3,2,5,0,3,4,0,2,4,1,3|8,10,7,6,4,0,6,2,0,6,2,0,7,3,0,7,1,3,8,0,1,7,3,1,5,4,0,8,2,0,5,3,2,
8,1,4,6,1,3,2,0,1,4,2,0,4,2,3,1,4,5|3,6,1,3,6,4,0,7,3,2,0,1,2,4,3,1,4,0,3,2,4,6,7,10,8,5,4,
2,5,0,1,5,2,1,8,3,2,8,1,0,6,1,0,5,3,2,8,0,4,7,0|4,7,2,3,5,0,3,2,1,0,4,2,3,4,1,3,0,4,6,8,10,
7,5,4,3,7,1,2,8,1,0,6,3,1,5,0,2,7,0,2,8,1,3,6,2,0,6,4,0,5,1&freeSpinReels-3,4,6,8,10,7,
5,4,1,5,3,1,8,2,0,6,2,0,7,1,2,8,0,3,7,0,1,6,0,3,5,2,0,4,1,0,4,2|2,4,5,7,10,8,6,4,0,7,1,2,6,
3,0,8,1,3,5,0,3,5,2,1,8,0,3,7,1,0,6,2,0,4,2,1,4,0|1,4,5,8,10,7,6,4,2,8,3,0,7,1,0,5,2,0,6,1,
3,7,2,0,6,3,1,5,0,2,8,0,1,4,2,0,4,3|0,4,6,7,10,8,5,4,3,6,1,2,5,3,2,4,1,0,4,2,0,4,1,0,4,2,1,
3,0,2,3,0,1,3,0,1,3,2,1|2,4,6,8,10,7,5,4,0,5,1,0,6,2,0,4,3,1,4,0,1,4,2,3,4,1,0,3,2,1,3,2,0,
3,1,0,2,1,3,0&winLines=1,1,1,1,1|0,0,0,0,0|2,2,2,2,2|0,1,2,1,0|2,1,0,1,2|0,0,1,2,2|2,2,1,
0,0|1,0,0,0,1|1,2,2,2,1|1,0,1,0,1|1,2,1,2,1|0,1,0,1,0|2,1,2,1,2|1,1,0,1,1|1,1,2,1,1|0,1,1,1,0
|2,1,1,1,2|0,2,0,2,0|2,0,2,0,2|2,2,0,2,2&bonusEntry=0&posReels=0,0,0,0,0&winnings
=0&winstr=&freeSpins=0&wilds=

The server may update the state information after every request/at each stage of the game. It may also store additional variables to the ones sent back to the game, for example an amount in game variable—this is used each time the state is saved so if there is a problem all the players current stake in that game can be returned. The state may be cleared when the game is finished (on round 0).

When the player presses the “Play” button, the stake is sent to the server in a bet string along with the number of lines (always 20 for this game). There may only be one bet placed at a time. The bet may for example be sent to the server in a bet string using a suitable format such as:
gameRound=G&action=COWNOR:C.CC:D&wildData=WIS.SS
Where:
“gameRound” is the current round the game is in (0 if didn't get any wilds on previous go, 1 if had some wilds)
“action” is the betstring, which is constructed as follows:
“COW” is unique 3 character code for this game
“NOR” is the bet type for normal bet (would be ‘FRE’ if it was a freespin request)
: delimiter
“C.CC” is the currency value of selected stake (per line) set to 2 decimal places (i.e. 1.50=£1,50)—This may need to be set to one of the available stake values for the selected currency.
: delimiter
“D” Details for the bet—this is the arbitrary multiplier value/ number of lines (always 20 for this game).
“wildData” contains details of the wilds. This is split into two parts using a “|” symbol. The first part is a comma separated list of wild symbols that the player chose to lock (or left blank if none are locked). These values may be in ascending order. The second part is the value of the stake the player placed to lock the wilds (this may be the same as total stake if none were locked). This value may be the total amount the player had to pay to do the spin with the wilds locked.
The server may check that the positions of wilds the player locked were actually wild symbols and also check that the cost for locking those matches the stakeWilds value sent,
Example spin request (normal spin—no wilds held):
gameRound=0&action=COWNOR:0.10:20&wildData=|2.00
This would be a stake of 10p on 20 lines (so total stake £2.50) and a normal spin.
Example for locked/custom wilds:
gameRound=0&action=COWNOR:0.10:20&wildData=2,10|3.10
Here the stake per line is still 0.10 but the wilds in positions 2 and 10 were locked and so the total cost was 3,10, in the example. The game round is the same as the server had returned on the previous response,
All variable names for sending/receiving data from the server may start with a lowercase letter but the start of each word may be upper case (eg “gameRound” or “posReels”).

As part of the main game, the Server is operative to return results. Typically, the server first validates the list of wilds sent by the game to hold were valid and were actually wilds from the previous spin (or position of wilds on the default reel positions of 0,0,0,0,0 if the first go on game).

In an example of game and server operation, the various parameters are not intended to be limiting. The server may generate 5 random numbers for the positions the reels should stop at (these numbers may be based on the length of the reels). These 5 numbers refer to the positions in the array of symbols on the reels. The position refers to the TOP line of symbols and the 2 symbols below these may then be set to the appropriate symbols based on the positions in the reel bandings. Once all the symbols have been calculated for the five reels, the server may make a list of the positions of all the wild symbols (which is returned to the game as well as being stored for future validation of the next request).

The server may then get a random number to see how many letters the player should get towards entry to the bonus round. This may be between 0 and 5 letters and may be based on a weighted array and a random number from the RNG between 1 and the total of this weighted array. A value of 5 would mean the player should gain entry to the freespins bonus round.

The server may make a list of all the reel wins and combine them all into a win string.
All this win data is then sent back to the game as follows:

&gameRound=0&posReels=56,78,64,55,20&symbols=2,1,3,5,2,6,1,5,2,6,0,9,0,2,3&f
reeSpins=0&winstr=4:2:3:2:1:0&winnings=2&balance=10030.5&bonusEntry=0#595
345549

Where:
gameRound is the new game round the game may need to enter (2 if they had 5 for the bonus entry and so triggered freespins, otherwise may be 0).
posReels is a comma separated list of the 5 reel stop positions (the position of the top line).
symbols is a comma separated list of the symbols shown on the reels (after wilds have been added)
bonusEntry is an integer between 0 and 5 and is how many letters the player may get towards the bonus free spins if provided. These are cleared for each spin,
winstr is a string that returns the details of the winning lines. It contains the data that the game needs to show details of each win and if there is more than one then they are split using “|”.

The structure is: |L:T:N:W:M:E
Where
L is the line number the win is on
T is the ID of the symbols that made up the win e.g. as described herein
N is the number of symbols that made up the win
W is the total amount won for that win (this may have been multiplied by stake already)
M is the multiplier for the line. (example: Always 1 for this game as no multipliers).
E is the extra data for that win (example: Blank in this game).
winnings is the total winnings for all the reel wins
freeSpins is the number of freespins remaining, if the feature is provided (example: 0 unless were in freespins already and had some left or had just triggered free spins), balance is the player's new balance (with their stake removed and the winnings added)
The “#” and number at end may be employed for checksum validation.

For each of the freespins, if such are provided, the player may send a freespin request e.g. as follows:
gameRound=2&action=COWFRE::
Suitable coding may be employed, e.g. the game round is always 2, in these requests. The game typically does not need to send details of the wilds or the stake as these are already known by the server and the stake remains the same as the last one they used before triggering freespins.

For each freespin the server may spin the reels as normal by getting 5 random stop positions and then setting the symbols to the ones in those positions. Any locked wilds may then be added over the top. The server would then return to the game the main details as it would for a normal spin (reel positions, list of wilds, win string etc). Additionally, the server may also return some or all of the following:
freeSpinsWins—this is the total amount won in freespins so far since the last normal spin. (This also includes the wins from the spin that triggered the free spins if provided).
Example response:

&gameRound=2&posReels=46,45,5,31,35&symbols=3,6,0,2,0,6,5,4,3,10,3,7,8,7,2&f
reeSpins=9&winstr=&winnings=0&balance=10039.5&bonusEntry=0&freeSpinsWins
=0#1610701896

Optionally, William Hill Checksum validation or an alternative thereto may be provided. If provided, the William Hill server may add a checksum number at the end of the response it sends to the front end. The front end may get the rest of the data from the response and produce its own checksum based on that and see if that checksum matches the one sent from the server.

If the checksums do not match, then something in the response has been changed (for example someone could have stopped the response from the server and tried changing the winnings or reel positions to make the front end look like the tampering party should have got an outcome different from what the tampering party actually got).

If the front end detects this then rather than processing the response, it may raise an error message and send an error to the checksum.asp file on the server which may log this message and raise it as a hack attempt for that player.

Any suitable conventional processing method may be used to generate the checksum and may be exactly the same for the front end and the server side ASP code.

It is appreciated that the details of the William Hill-ASP-single client implementation particularly described herein are set out merely by way of example are is not intended to be limiting since many alternative implementations are possible as is known in the art.

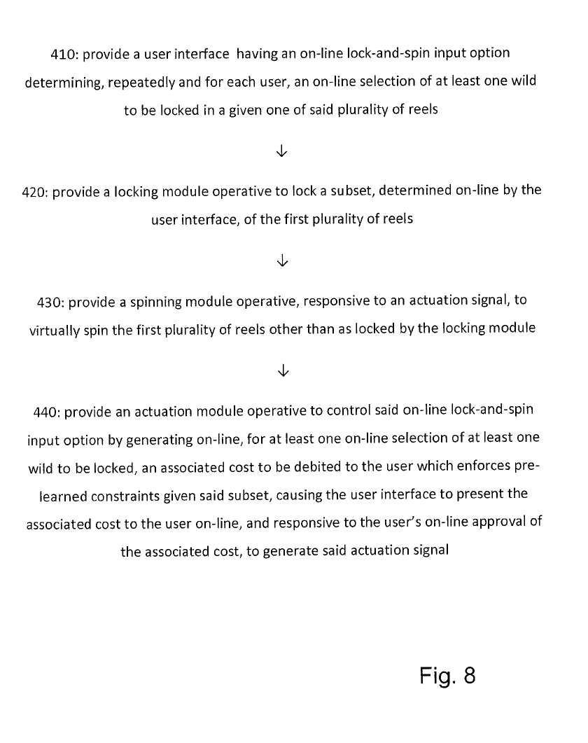

Reference is now made to FIG. 8 which is a simplified diagram of a method for controlling a computerized reel-based game system according to an embodiment of the present invention. According to the method of FIG. 8, some or all of the following steps may be performed, suitably ordered e.g. as shown:

Step 410: provide a user interface having an on-line lock-and-spin input option determining, repeatedly and for each user, an on-line selection of at least one wild to be locked in a given one of said plurality of reels.

Step 420: provide a locking module operative to lock a subset, determined on-line by the user interface, of the first plurality of reels.

Step 430: provide a spinning module operative, responsive to an actuation signal, to virtually spin the first plurality of reels other than as locked by the locking module.

Step 440: provide an actuation module operative to control said on-line lock-and-spin input option by generating on-line, for at least one on-line selection of at least one wild to be locked, an associated cost to be debited to the user which enforces pre-learned constraints given said subset, causing the user interface to present the associated cost to the user on-line, and responsive to the user's on-line approval of the associated cost, to generate said actuation signal.

An example application of and implementation of the method of FIG. 8 is now described, for an example computerized gambling game which is not intended to be limiting. The implementation described includes dynamic price computation and determination of different wild combinations for when the player wants to decrease/increase her or his current Lock & Spin staking level using computerized game functionality as described herein. An example data set, some or all of which may be supplied to the server in order for the server to dynamically calculate the cost of any wild configuration the server may be presented with, in the course of an unpredictable on-line gambling game, is also described herein and is not intended to be limiting,

This example assumes a slot game, having some or all of the characteristics described below, where the player can select any possible permutation of wild symbols on the reels, which would act upon the results of the next spin on the slot machine. When a player adds wild symbols to those already in view, the player is creating a higher chance of wins occurring on the next spin. If the player were allowed to play at the base stake level that is in place for conventional games that do not allow this kind of user interaction, the game would pay-out at a rate that exceeds the stake amount on every single spin and therefore would not be profitable or hence feasible for the operator. In order to generate a game which does operate at a predictable and appropriately profitable and legal, as per pre-known rules, pay-out level relative to the player stake, propositions to the player are generated on-line so as to be changed in tandem with the customisable configuration of wilds to be used on the next spin. The stake level presented to the player for adding wilds to their next spin automatically adjusts, on-line, relative to the increased average win amount for that configuration of wilds e.g. in order to maintain a pay-out ratio that matches the ratio of playing the game conventionally i.e. such that wilds are not added and spins are played at base stake level.

According to one embodiment, the effects of every different permutation of wilds on the pay-out return of the game are computed, when using a single win line. The stored data from this single win line is used to calculate the total effect on the full complement of lines available in the game. Working backwards from what the pay-out return is on these different permutations when not changing the stake from the base level, a pricing level is typically provided, relative to the base stake for each of the permutations. The pricing level creates a predictable pay-out return for all permutations of wilds which may occur during the game, from no wilds on the reels to all reel symbols being wild. This allows a dataset to be exported which is subsequently used by the game logic to dynamically determine what any configuration of wilds selected by the player is to cost, to be used as a stake on the next spin. The total cost for any wilds selected by the user may be calculated dynamically by adding up the individual costs of each of the win lines available in the game, based on which wild configurations exist on each of these lines. This cost is then presented to the player. Typically, only upon user authorization of or remittance of such cost, the actual game operation e.g. lock and spin, is actuated.

Example:
1) When the game loads up, some or all of the following conditions may be set:
   a) Optionally, at least one visible symbol e.g. the middle visible symbol on reel 3 is set as a wild.
   b) Auto-Lock is ON.
   c) The Lock & Spin stake accounts for the current normal spin stake and the reel 3 wild that is in place,
      i) For example, if the normal spin stake is £2, then the Lock & Spin stake appears as £6,96. If the reel 3 wild is removed by the player, then the Lock & Spin stake decreases to match the normal spin stake (£2),
      ii) Any suitable computational method may be used for calculating the cost of wild permutations dynamically within the game logic, such as the wild permutation cost computation method described below,
2) The player may switch Auto-Lock OFF in the game options.
   a) If Auto-Lock is ON, then any wilds that land while Lock & Spin is in play may be automatically added to the locked wilds.
      i) In this case, new wilds may cause the Lock & Spin stake to increase, and further play may continue at this increased stake.
   b) If Auto-Lock is OFF, new wilds that land may not be locked automatically unless the player clicks on them to select them.
   i) In this case, the Lock & Spin stake may not increase at all e.g. until the player manually selects new wilds or changes the normal spin stake.
3) Wilds that are locked in place (either automatically or manually) have a pre-selected icon e.g. padlock icon on them, which is visible when the player moves the mouse over the reels area or the Lock & Spin button.
4) The player can lock /unlock wilds in any symbol position on any reel e.g. by clicking on the symbol they wish to alter.
   a) Clicking on a normal symbol is denoted for the user e.g. by overlays with a suitable overlay indicator or symbol e.g. a locked wild symbol.
      i) The symbol may be visibly replaced by a wild symbol (with a suitable e.g. padlock icon when the mouse is rolled over the reels or the Lock & Spin button).
      ii) The Lock & Spin stake increases to reflect the new symbol.
      iii) Typically, the player can lock between 0-15 symbols, in any permutation.
   b) Clicking on a wild symbol either removes the overlaid locked wild, or changes it into a normal symbol.
      i) If the wild symbol was originally placed/locked by the player, and the usual symbol position on the reels is a normal symbol (say, 10, J, Q, K, A, Flamingo, Zebra, Leopard, Rhino), then the wild symbol being clicked on reverts to that symbol,
      ii) If the wild symbol spun in naturally or the overlaid locked wild is placed in a position that would normally have a wild according to the reel layouts, then the symbol may revert to (say) a 10 symbol (for the purposes of visual effect; spinning again places the wild back into its usual position on the reel).
      iii) The Lock & Spin stake decreases to reflect the removal of the wild.
5) When at least 1 wild is locked on the reels, the Lock & Spin stake field has the current value of 1 spin displayed. UP and DOWN arrow buttons or similar controls may be situated appropriately e.g. next to this value.
   a) The UP arrow may be greyed out while all wilds locked by the player are visible on the reels (e.g. the Lock & Spin stake is at the maximum value chosen by the player or defined by new wilds spinning in via Auto-Lock),
   b) Clicking the DOWN arrow decreases the Lock & Spin stake to its next possible lowest value by shuffling the locked wilds, typically using some or all of the following rules:
      i) Any number of wilds can be used, up to the number originally locked in place (e.g. if the DOWN button is first pressed while 5 wilds are locked, any number of wilds between 0-5 can be used).
      ii) Wilds may only be placed in positions originally used by wilds before the DOWN button is pressed for the first time. For example, if the 3 symbol positions on reel 2 are the only positions with wilds locked in place, then only the positions on reel 2 can be used.
   c) Typically, as long at these rules are followed, pressing the DOWN button may not necessarily remove a wild; it may instead rearrange the existing locked wilds to produce the next lowest-value pattern.
      i) pressing the DOWN button could remove a wild (e.g. the first time the button is pressed), but may also re-add a wild and rearrange the others in a different pattern to produce a lower Lock & Spin stake.
   d) Pressing the UP button typically reverses this process, rearranging the locked wilds in the player's chosen positions to give incrementally higher Lock & Spin stakes until the original value is returned (e.g. using all of the original lock wilds in their original positions).
   e) Any suitable computational or logical method may be employed for determining which permutations and costs are available in the Lock & Spin stake field, such as but not limited to the permutation/cost availability determination method described in detail below.
6) Typically, the reels are spun using either the SPIN or the LOCK & SPIN buttons.
   a) Typically, pressing the SPIN button spins the reels and ignores any locked wilds, whether placed manually by the player or by the Auto-Lock feature. Any locked wilds on the reels may, optionally, disappear when the reels start to spin. Each spin uses the normal stake value.
      i) Any wilds that spin in naturally using the SPIN button act as normal wilds, substituting for any other symbol to calculate line wins.
      ii) If the Auto-Lock feature is ON, then these new wilds may lock in place, as may any other wilds the player subsequently adds by clicking on the reel symbols. The Lock & Spin stake value increases to reflect the new wilds. However, using the SPIN button again may negate these new locked wilds.
   b) Typically, pressing the LOCK & SPIN button spins the reels, keeping any locked wilds in position over the spinning reels. Each spin uses the current Lock & Spin stake value.
      i) When the reels stop spinning, any symbols hidden by the locked wilds typically act as wilds, substituting for any other symbol to calculate line wins.
      ii) Any new wilds that spin in naturally using the LOCK & SPIN button also typically act as normal wilds in the same way.
         (1) If Auto-Lock is ON, then these new wilds lock in place with any existing locked wilds for the next spin. The Lock & Spin stake value increases to reflect the new wilds.
         (2) If Auto-Lock is OFF, then any new wilds may not be locked in place for the next spin; pressing the LOCK & SPIN button may only keep the original set of locked wilds for the next spin.
      iii) Either way, the player can place further new wilds manually, or remove any wilds they see fit (either from their original locked wilds or the new ones); the Lock & Spin stake value alters to reflect the new values as outlined earlier.

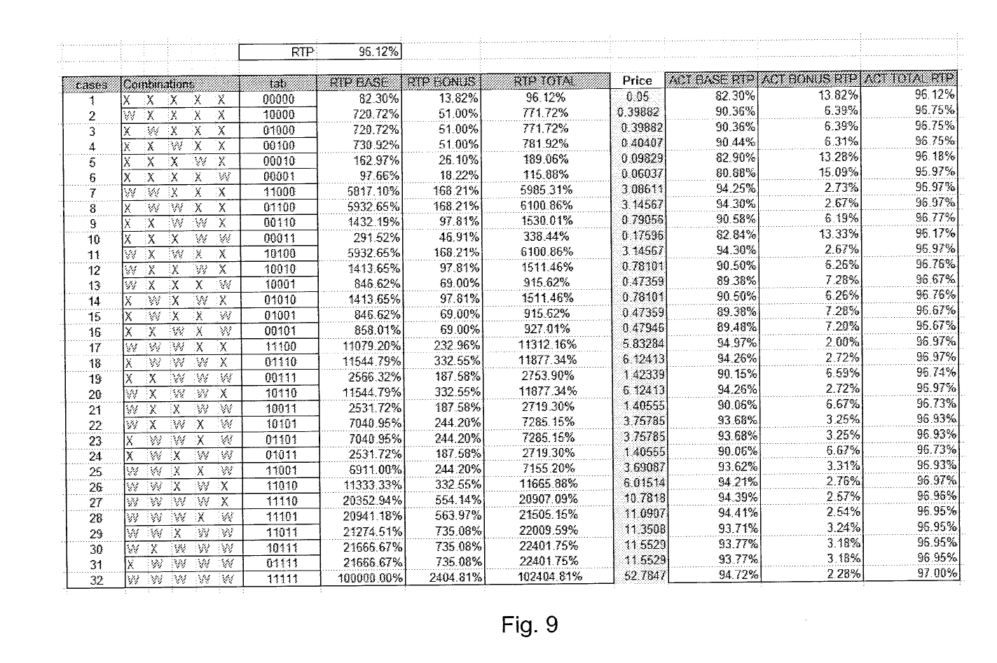

An example method by which a computer processor may calculate the cost of wild permutations dynamically within a game logic is now described in detail:
1) There are 32,768 permutations of wild layouts on the reels in a 3×5 (5 reels, 3 high) slot game. This is calculated as follows:
   a) 15 symbols in view (3×5) with each symbol having 2 possible states—has a wild or does not have a wild.
   b) This results in: 2̂15=32,768
2) On each win line in the game there are 32 permutations of wilds (5 symbols on each line). This is calculated as follows:
   a) There are 5 symbols on any given win line (due to there being 5 reels) with each symbol having 2 possible states—has a locked wild or does not have a locked wild.
   b) This results in 2̂5=32
3) There are 20 win lines in Wild Gambler. These are fixed and cannot be altered by the player.
An example computational method for generating a look up table for the cost of every permutation of wild layouts possible in the game, is now described in detail.
1) For each of the 32,768 permutations:
   a) For each of the 20 win lines:
      i) Retrieve the cost for this win line from the dataset based on the wild pattern that is formed on the win line. This is based on the in view wild layout permutation currently being processed.
         (1) Any suitable computational method may be employed to generate the cost of a wild permutation on any given win line e.g. as described below with reference to FIG. 9 which yields an example price data set with relevant information coming from the ‘Combinations’ and ‘Price’ columns of FIG. 9.
      ii) The cost is typically calculated against a base stake of 1.00. This facilitates adaptation to any changes the player makes to their base stake without having to recalculate the look up table, as the final cost may always be calculated by multiplying the stored cost by the current base stake that the user has set in the game. Typically, the operation of multiplying the cost by the player's current base stake is carried out every time that the cost is displayed to the player for Lock & Spin regardless of what caused the Lock & Spin stake to change.
   b) The total cost for this permutation may be defined as the sum of all the costs of the individual win lines as calculated above.
2) The look up table may be sorted by its wild permutation ID, with a separate ID for each of the 32,768 permutations. Each ID is the first 15 (in the illustrated example where the visible window has 3×5=15 positions) bits of a 32 bit integer, where each of the first 15 bits represents a position in the in view reels area (e.g. 3×5). If a wild exists in view at the position corresponding to the bit in question, then the bit is set to 1. If no wild exists at this position, the bit is set to 0, such that each of the first 15 (e.g.) bits stands for a wild on-off switch.
3) Permutation ID examples:
   a) 00000000000000000111111111111111
      i) This number is the equivalent of 32,767 but refers to permutation 32,768 because base is used at 0 rather than 1.
      ii) As can easily be seen, permutation 32,768 consists of fifteen 1's which means that all symbols in view are wild symbols.
   b) 00000000000000000000000000000000
      i) This number is the equivalent of 0 but refers to permutation 1 because base is used at 0 rather than 1.
      ii) As can easily be seen, permutation 1 consists of fifteen 0′s which means that all symbols in view are not wild symbols.
An example method for determining the cost of a wild configuration is now described in detail:
1) The wild configuration may have come about:
   a) As a result of the player adding or removing wilds manually
   b) As a result of wilds landing in view through normal game play from the last spin
   c) As a combination of both possibilities.
2) The price presented to the player changes typically immediately upon any alteration to the wild configuration in view to reflect the new cost of spinning with this configuration.
3) When any change to the wild layout is made:
   a) A wild permutation ID is created by using the first 15 (say) bits of a 32 bit integer to represent the 15 positions in view in the game e.g. by setting the corresponding bit to 1 if a wild exists in that position in the game or setting it to 0 if no wild exists in this position.
   b) Any wild permutation IDs that have already been created and stored in the creation of the look up table as described herein, typically use the exact same format and can therefore be directly referenced using the ID that was created dynamically to reflect the current wild configuration. Therefore, the wild permutation Ids can be used to retrieve the total cost to spin for this permutation from the pre-calculated and computer-memory stored look up table.

An example method whereby a computer processor may determine which permutations and costs are available in the Lock & Spin stake field, is now described in detail:
1) This operation takes place every time the wild configuration is changed by any means:
   a) All possible sub-permutations of the current wild configuration are determined by the code.
      i) If, for example, 2 wilds exist in view then the original permutation is: (1) Wild 1 on and Wild 2 on
      ii) The 3 possible sub-permutations of the original permutation above are:
         (1) Wild 1 on and Wild 2 off
         (2) Wild 1 off and Wild 2 on
         (3) Wild 1 off and Wild 2 off
   b) This is done by going through every one of the 32,768 possible permutations and checking each one for whether it is a sub-permutation of the original configuration or not (relevant or not). One example implementation, which is not intended to be limiting, employs a bitwise NOT operation on the current layout, together with a bitwise AND operation on each item, to indicate whether or not a current permutation is or is not a sub-permutation.
   c) If the permutation being checked is a sub-permutation, the ID is added to a list that is typically created and populated dynamically by this process.
2) Once the above process is completed, the final list is ordered from highest to lowest by the associated total costs for each valid permutation ID and, typically, is displayed at least in part to the user.
3) The player can use the buttons on the game console to change to the next lowest or highest Lock & Spin stake from their current Lock & Spin stake and this would result in:
   a) The appropriate stake being displayed along with the wild configuration in the in view area of the game changing to the permutation dictated by this price.
   b) The wild layout is easily changed because the permutation ID, which is the first 15 bits of a 32 bit integer, is by definition a representation of whether or not a wild exists (the corresponding bit having been set to 1 in the ID) or not (the corresponding bit having been set to 0 in the ID) in the associated position in the game.
4) The highest possible stake that can be accessed as above is the original stake based on the original wild configuration that started this process of finding any and all sub-permutations.
5) The lowest possible stake that can be accessed as above is when all wilds have been removed from view leaving the Lock & Spin stake equal to the normal Spin stake,
6) The total number of prices available is always cut down to an easily displayable number o f options e.g. a maximum of say 30 options so as not to overwhelm the player.
   a) These 30 (say) values may be evenly selected from the total list compiled as described above.
   b) For example, if there are 300 values actually available in the list, every 10^{th} value may be offered.
   c) A minimum separation in cost e.g. of 0.01 units, may be applied so if multiple values in the list of 30 had the same value, only 1 of those at that value would be used and displayed.

Certain embodiments of the present invention may have some or all of the following features:
1) A spreadsheet may be created in computer memory to model a given computerized gambling game where the pay-out return is calculated for every possible permutation of wilds on a single win line.
2) The inputs for the spreadsheet may include some or all of:
   a) The reel layouts (e.g. 5 reels)
   b) The pay-outs awarded for combinations of symbols appearing on a win line—note, this slot machine uses the most common awarding system which is that wins pay left to right.
   c) The configuration of win lines (20 lines e.g.).
   d) Either the desired price or desired RTP for each of the 32 cases (per line) or 32,768 permutations (per 20 lines), as the chance is calculated using the above three (reel layouts, pay-outs, line layouts) these are intrinsically linked One can either enter a desired price and be told what RTP this may yield or vice versa.
3) The pay-out return is defined as how much the player would get in return for a stake of 1 unit. The pay-out itself would be a multiple of this staking unit,
4) The returns are used to calculate prices that may enforce a chosen RIP (return to player) and Casino Margin.
   a) For example: If playing at a 1 unit stake the player on average gets 4,75 units back, then charge them 5 units to play this game and paying out on 1 unit as before would yield a 95% RTP or a 5% Casino Margin (4.75/5).
5) With a total of 5 symbols possible on every win line with 2 possible states each (has a wild or does not have a wild), this results in 32 permutations (2̂5).
6) The pay-out return is calculated for the base game (the normal reels game of the slot machine) and the bonus game (e.g. the free spins feature in the game). It is appreciated that, of course, any type of bonus feature, such as but not limited to free spins, may be provided in conjunction with the embodiments shown and described herein, or no bonus feature may be provided.
7) The calculations for the bonus game are useful in that whatever wild configuration was being used when the bonus game is triggered may be the starting configuration for the free spins (say) and may remain locked for the duration of the bonus round. Any additional wilds that spin in during the free spins if provided may also remain locked from the point that they spun in till the end of the bonus round.
8) Using the resulting total pay-out return (base reels return +bonus return), a price or cost can be configured for each of the 32 possible permutations of wilds on a single win line in order to adjust the actual total return for that wild permutation in the game to be at a predictable level that is in line with the base pay-out return level where no wilds are used.
9) An example pricing table, some or all of which may be employed, is shown in FIG. 9.

Referring now to FIG. 9:
a) In the table of FIG. 9, 32 cases exist for wild permutations on a single win line (‘cases’ and ‘Combinations’ columns).
b) For each case, a separate tab in the spreadsheet has been used to determine the pay-out return for that case (tab' column) using standard practices.
c) These pay-out returns may then be imported for the base reels (‘RTP BASE’ column) and the bonus game (‘RTP BONUS’ column) in this table allowing the total pay-out return to be presented (‘RTP TOTAL’ column which is a summation of ‘RTP BASE’ and ‘RTP BONUS’).
d) In the illustrated example, a base price of 0.05 is used for the case that has no wilds (case 1) so that the total stake works out to 1.00 as the game has 20 fixed win lines in use.
e) All other prices are typically adjusted either upwards or downwards relative to the base stake of 0.05 per win line in order to achieve actual return pay-outs in the game (based on the higher or lower stake for this case) that closely match the return of case 1.
f) This is apparent by the actual base game return (‘ACT BASE RTP’ column), actual bonus return (‘ACT BONUS RTP’ column) and the actual total return (‘ACT TOTAL RTP’ column) where the values for the case 1 (where no wilds are in operation) remain identical to their calculated counterparts (‘RTP BASE’, ‘RTP BONUS’ and ‘RTP TOTAL’ columns) while for all other cases this differs owing to the effect that changing the pricing of that permutation has on its calculated return.
g) The final list of prices (‘PRICE’ column) per permutation is what is provided to the game logic as a data set to then be used to dynamically work out the cost of any possible wild configuration that it is presented with e.g. as described above.
10) The output may include RTP per case or price per case depending on which one of these 2 were used as an input at the start; using RTP as an input yields price as an output while using price as an input yields RTP as an output.

The methods shown and described herein are particularly useful in processing systems including hundreds, thousands, tens of thousands, or hundreds of thousands of gaming possibilities and outcomes since such large bodies of data can only be processed, analyzed, sorted, or searched using computerized technology.

It is appreciated that terminology such as “mandatory”, “required”, “need” and “must” refer to implementation choices made within the context of a particular implementation or application described herewithin for clarity and are not intended to be limiting since in an alternative implementation, the same elements might be defined as not mandatory and not required or might even be eliminated altogether.

It is appreciated that software components of the present invention including programs and data may, if desired, be implemented in ROM (read only memory) form including CD-ROMs, EPROMs and EEPROMs, or may be stored in any other suitable typically non-transitory computer-readable medium such as but not limited to disks of various kinds, cards of various kinds and RAMs. Components described herein as software may, alternatively, be implemented wholly or partly in hardware, if desired, using conventional techniques. Conversely, components described herein as hardware may, alternatively, be implemented wholly or partly in software, if desired, using conventional techniques.

Included in the scope of the present invention, inter alia, are electromagnetic signals carrying computer-readable instructions for performing any or all of the steps of any of the methods shown and described herein, in any suitable order; machine-readable instructions for performing any or all of the steps of any of the methods shown and described herein, in any suitable order; program storage devices readable by machine, tangibly embodying a program of instructions executable by the machine to perform any or all of the steps of any of the methods shown and described herein, in any suitable order; a computer program product comprising a computer useable medium having computer readable program code, such as executable code, having embodied therein, and/or including computer readable program code for performing, any or all of the steps of any of the methods shown and described herein, in any suitable order; any technical effects brought about by any or all of the steps of any of the methods shown and described herein, when performed in any suitable order; any suitable apparatus or device or combination of such, programmed to perform, alone or in combination, any or all of the steps of any of the methods shown and described herein, in any suitable order; electronic devices each including a processor and a cooperating input device and/or output device and operative to perform in software any steps shown and described herein; information storage devices or physical records, such as disks or hard drives, causing a computer or other device to be configured so as to carry out any or all of the steps of any of the methods shown and described herein, in any suitable order; a program pre-stored e.g. in memory or on an information network such as the Internet, before or after being downloaded, which embodies any or all of the steps of any of the methods shown and described herein, in any suitable order, and the method of uploading or downloading such, and a system including server/s and/or client/s for using such; and hardware which performs any or all of the steps of any of the methods shown and described herein, in any suitable order, either alone or in conjunction with software. Any computer-readable or machine-readable media described herein is intended to include non-transitory computer- or machine-readable media.

Any computations or other forms of analysis described herein may be performed by a suitable computerized method. Any step described herein may be computer-implemented. The invention shown and described herein may include (a) using a computerized method to identify a solution to any of the problems or for any of the objectives described herein, the solution optionally include at least one of a decision, an action, a product, a service or any other information described herein that impacts, in a positive manner, a problem or objectives described herein; and (b) outputting the solution.

The scope of the present invention is not limited to structures and functions specifically described herein and is also intended to include devices which have the capacity to yield a structure, or perform a function, described herein, such that even though users of the device may not use the capacity, they are if they so desire able to modify the device to obtain the structure or function.

Features of the present invention which are described in the context of separate embodiments may also be provided in combination in a single embodiment.

For example, a system embodiment is intended to include a corresponding process embodiment. Also, each system embodiment is intended to include a server-centered “view” or client centered “view”, or “view” from any other node of the system, of the entire functionality of the system, computer-readable medium, apparatus, including only those functionalities performed at that server or client or node.

Conversely, features of the invention, including method steps, which are described for brevity in the context of a single embodiment or in a certain order may be provided separately or in any suitable subcombination or in a different order. “e.g.” is used herein in the sense of a specific example which is not intended to be limiting. Devices, apparatus or systems shown coupled in any of the drawings may in fact be integrated into a single platform in certain embodiments or may be coupled via any appropriate wired or wireless coupling such as but not limited to optical fiber, Ethernet, Wireless LAN, HomePNA, power line communication, cell phone, PDA, Blackberry GPRS, Satellite including GPS, or other mobile delivery. It is appreciated that in the description and drawings shown and described herein, functionalities described or illustrated as systems and sub-units thereof can also be provided as methods and steps therewithin, and functionalities described or illustrated as methods and steps therewithin can also be provided as systems and sub-units thereof. The scale used to illustrate various elements in the drawings is merely exemplary and/or appropriate for clarity of presentation and is not intended to be limiting.

1-33. (canceled)

34. A computerized reel-based game system comprising:
an array of indicators ordered as a result of a random or pseudorandom spin of a plurality of reels;
a processor adapted to apply a set of rules to the location of the indicators in the array to determine an outcome category corresponding to the particular array of indicators;
a user interface adapted to enable user-initiated positioning of one or more overlay indicators at one or more selectable positions in the array, thus giving rise to one or more selected positions;
a lock unit adapted, responsive to an actuation command, to replace one or more indicators to be positioned in the respective positions resulting from a next random or pseudo-random spin of the reels by said one or more overlay indicators, wherein the processor is further adapted to apply the set of rules to the resulted array with said one or more overlay indicators in the selected positions; and
an actuation module adapted to calculate, responsive to said user-initiated positioning of said one or more overlay indicators, a stake to be paid in accordance with the selected one or more positions and a cost associated therewith, to enable presenting the associated cost via the user interface and, responsive to the user's approval of the stake, to generate said actuation command and send it to the lock unit,
wherein the actuation module is further adapted to identify, for each line of the array, a permutation of the selected positions in the line among a predefined set of all possible permutations of the selected positions in a line, each combination in the predefined set includes a predefined cost; and to calculate the stake to be paid using the predefined costs of the identified combinations.

35. The system of claim 34, wherein the actuation module is operative for on-line generation of an associated cost to be debited to the user enforcing pre-learned constraints for a subset of reels to be locked which is determined on-line.

36. The system of claim 34, wherein a first and a second user initiator are provided to start the random or pseudo-random ordering process,
wherein the first user initiator configured to start the process without the one or more overlay indicators registering their selected positions in the array with the processor such that the processor applies the set of rules to the location of the indicators in the array excluding the one or more overlay indicators at their selected positions; and
the second user initiator configured to start the process with the one or more overlay indicators registering their selected positions in the array with the processor such that the processor applies the set of rules to the location of the indicators in the array including the one or more overlay indicator at their selected positions.

37. The system of claim 34, wherein for at least one on-line positioning of said one or more overlay indicators, the actuation module is further adapted to calculate a return value to indicate a monetary amount that a player would receive in return for spinning a one-unit stake using a one-line slot machine, based on payouts being multiples of said unit.

38. The system of claim 37, wherein said return value is computed repeatedly by said actuation module, once for each possible permutation of selected positions on a single line, thereby to yield a total of r return values, where r=2 exp s, where s=the number of symbols per line.

39. The system of claim 38, wherein the actuation module generates a component cost, enforcing pre-learned constraints, for each of the r return values, thereby to yield a total of r component cost values.

40. The system of claim 39, wherein the actuation module is operative for generating a total cost, enforcing said constraints, for at least one configuration of one or more overlay indicators, said generating comprising:
comparing each individual line from among a second plurality of lines with the possible permutations of selected positions and identifying an individual matching permutation to match said individual line, thereby to define a second plurality of matching permutations; and
summing the component costs generated for each of the return values computed for each of said second plurality of matching permutations.

41. The system of claim 34, wherein said spin of the reels is operative in accordance with the on-line selection of position of at least one overlay indicator; while the selection is in effect, each spin retains each such overlay indicator in the given one of said plurality of reels.

42. The system of claim 34 wherein said reels comprise virtual reels.

43. A method of operating a computer-based game system comprising an array of indicators orderable as a result of a random or pseudorandom spin of a plurality of reels, the method comprising:
storing in a memory of the computer selected by a user positions of one or more overlay indicators at one or more selectable positions in the array, thus giving rise to one or more selected positions;
calculating, by the computer, a stake to be paid in accordance with the selected one or more positions and a cost associated therewith,
responsive to the user's approval of the stake to be paid, generating, by the computer, an actuation command;
responsive to the generated actuation command, replacing one or more indicators to be positioned in the respective positions resulting from a next random or pseudo-random spin of the reels by said one or more overlay indicators;
wherein calculating the stake comprises identifying, for each line of the array, a permutation of the selected positions in the line among a predefined set of all possible permutations of the selected positions in a line, each combination in the predefined set includes a predefined cost; and calculating the stake to be paid using the predefined costs of the identified combinations.

44. The method of claim 43, wherein random or pseudo-random spin is initiated by a first and a second user,
the first user initiator starting the process without the one or more overlay indicators registering their selected positions in the array with the processor such that the processor applies a set of rules to the location of the indicators in the array excluding the one or more overlay indicators at their selected positions; and
the second user initiator starting the process with the one or more overlay indicators registering their selected positions in the array with the processor such that the processor applies the set of rules to the location of the indicators in the array including the one or more overlay indicator at their selected positions.

45. The method of claim 43, further comprising calculating for at least one on-line positioning of said one or more overlay indicators, a return value indicating a monetary amount that a user would receive in return for spinning a one-unit stake using a one-line slot machine, based on payouts being multiples of said unit.

46. The method of claim 45, wherein said return value is computed repeatedly, once for each possible permutation of selected positions on a single line, thereby to yield a total of r return values, where r=2 exp s, where s=the number of symbols per line.

47. The method of claim 46, further comprising generating a component cost, enforcing pre-learned constraints, for each of the r return values, thereby to yield a total of r component cost values.

48. The method of claim 47, further comprising generating a total cost, enforcing said constraints, for at least one configuration of one or more overlay indicators, said generating comprising:
comparing each individual line from among a second plurality of lines with the possible permutations of selected positions and identifying an individual matching permutation to match said individual line, thereby to define a second plurality of matching permutations; and
summing the component costs generated for each of the return values computed for each of said second plurality of matching permutations.

49. The method of claim 43, wherein spinning the reels is provided in accordance with the on-line selection of position of at least one overlay indicator; while the selection is in effect, each spin retains each such overlay indicator in the given one of said plurality of reels.

50. The method of claim 43 wherein said reels comprise virtual reels.

51. A computer program product comprising a non-transitory computer usable medium having computer readable program code embodied therein for operating a computerized reel-based game system comprising an array of indicators orderable as a result of a random or pseudorandom spin of a plurality of reels, the computer program product comprising:
computer readable program code for causing the computer to enable user-initiated positioning of one or more overlay indicators at one or more selectable positions in the array, thus giving rise to one or more selected positions;
computer readable program code for causing the computer to calculate, responsive to said user-initiated positioning of said one or more overlay indicators, a stake to be paid in accordance with the selected one or more positions and a cost associated therewith, computer readable program code for causing the computer to generate an actuation command responsive to a user's approval of the stake to be paid;
computer readable program code for causing the computer to replace, responsive to the generated actuation command, one or more indicators to be positioned in the respective positions resulting from a next random or pseudo-random spin of the reels by said one or more overlay indicators;
wherein calculating the stake comprises identifying, for each line of the array, a permutation of the selected positions in the line among a predefined set of all possible permutations of the selected positions in a line, each combination in the predefined set includes a predefined cost; and calculating the stake to be paid using the predefined costs of the identified combinations.
